(19) United States
(12) Patent Application Publication
(10) Pub. No.: US 2022/0342835 A1
(43) Pub. Date: Oct. 27, 2022

(54) METHOD AND APPARATUS FOR DISAGGREGATION OF COMPUTING RESOURCES

(71) Applicant: ELECTRONICS AND TELECOMMUNICATIONS RESEARCH INSTITUTE, Daejeon (KR)

(72) Inventors: Daeub KIM, Daejeon (KR); Jongtae SONG, Daejeon (KR)

(21) Appl. No.: 17/535,761

(22) Filed: Nov. 26, 2021

(30) Foreign Application Priority Data
Apr. 26, 2021 (KR) 10-2021-0053585

(51) Int. Cl. G06F 13/16; G06F 13/28

(52) U.S. Cl. CPC G06F 13/1689; G06F 13/28

(57) ABSTRACT

A method and an apparatus for disaggregation of computing resources are disclosed. A disaggregation controller according to an example embodiment includes a disaggregation control agent configured to determine a requester that is to perform a data read or write operation of a processing unit for a disaggregated memory based on a disaggregated memory delay corresponding to the disaggregated memory, a disaggregation direct access requester configured to perform the read or write operation if the disaggregated memory delay is equal to or less than a threshold value, and a disaggregation indirect access requester configured to perform the read or write operation if the disaggregated memory delay is greater than the threshold value.

### CROSS-REFERENCE TO RELATED APPLICATION

This application claims the benefit of Korean Patent Application No. 10-2021-0053585, filed on Apr. 26, 2021, in the Korean Intellectual Property Office, the entire disclosure of which is incorporated herein by reference for all purposes.

### BACKGROUND

### 1. Field of the Invention

One or more example embodiments relate to a method and an apparatus for disaggregation of computing resources.

### 2. Description of Related Art

Modern data processing and data communication networks must accommodate various services related to artificial intelligence, autonomous driving, robotics, healthcare, virtual/augmented reality and home networks. Therefore, the processing performance and efficiency of the cloud existing in the data center is emphasized, and a computer architecture and system suitable for the increasing amount of data are required because a large amount of data processing and calculation is required.

### SUMMARY

Example embodiments provide techniques regarding connections between disaggregated processing units, accelerators, and memories so that disaggregation of computing resources may be performed through collaboration between large-scale programs, data sharing of each processing unit, and access to aggregated memories by utilizing physically disaggregated processing units and memories.

However, the technical objects are not limited to the above-described ones, and other technical objects may exist.

According to an aspect, there is provided a disaggregation controller including: a disaggregation control agent configured to determine a requester that is to perform a data read or write operation of a processing unit for a disaggregated memory based on a disaggregated memory delay corresponding to the disaggregated memory; a disaggregation direct requester configured to perform the read or write operation if the disaggregated memory delay is less than or equal to a threshold value; and a disaggregation indirect requester configured to perform the read or write operation if the disaggregated memory delay is greater than the threshold value.

The disaggregated memory delay may be a sum of a delay according to a distance to the disaggregated memory and a delay occurring in the disaggregation controller connected to the processing unit via a memory bus, and a delay according to performance and a response speed of the disaggregated memory.

The disaggregation control agent may be configured to: determine a port to be connected to the disaggregated memory based on a memory address corresponding to the read or write operation, manage a disaggregated memory delay value for each connectable disaggregated memory; and operate according to a request and response protocol of a memory bus and a bus switch connected to the disaggregation controller so that the processing unit recognizes the disaggregation controller as a combination of one memory controller and one memory, and distinguish between a direct access state and an indirect access state.

The disaggregation direct requester and the disaggregation indirect requester may be configured to generate a request disaggregated memory frame according to the read or write operation, transmit the request disaggregated memory frame to the disaggregated memory, and terminate a received response disaggregated memory frame.

If the processing unit performs a read or write operation, the disaggregation direct requester may be configured to generate a request disaggregated memory frame including write data in case of a write operation, transmit the request disaggregated memory frame to the disaggregated memory, receive a response disaggregated memory frame including read data in case of a read operation from the disaggregated memory, and transmit a memory bus response signal for informing a read data and read state in case of a read operation or a write state in case of a write operation to the processing unit through a memory bus.

If the processing unit performs a write operation, the disaggregation indirect requester may be configured to: return an indirect access response signal including state information for checking a state in which a write request is performed to the processing unit through a requested memory bus, before the disaggregated memory responds; designate a memory address and a memory space accessible by the processing unit and the disaggregation indirect requester and used to check a response state of the disaggregated memory; generate a request disaggregated memory frame including write data and transmit the request disaggregated memory frame to the disaggregated memory; receive a response disaggregated memory frame from the disaggregated memory; display a response state of the disaggregated memory to the write request in a memory address of a memory accessible by the processing unit; and notify the processing unit that the response state of the disaggregated memory to the write request has been updated.

If the processing unit performs a read operation, the disaggregation indirect requester may be configured to: return an indirect access response signal including state information for checking a state in which a read request is performed to the processing unit through a requested memory bus, before the disaggregated memory responds; designate a memory address and a memory space accessible by the processing unit and the disaggregation indirect requester and used to check a response state of the disaggregated memory and read data; generate a request disaggregated memory frame for performing a read operation and transmit the request disaggregated memory frame to the disaggregated memory; receive a response disaggregated memory frame including read data from the disaggregated memory; store the read data and a response state of the disaggregated memory to the read request in the received response disaggregated memory frame in a memory space of a memory address identifiable by the processing to unit; and notify the processing unit that a read state of the disaggregated memory and the read data have been updated.

According to an aspect, there is provided a computing system including: a processing unit; a main memory; a disaggregation controller configured to control a read or write operation for a disaggregated memory of the processing unit; and a memory bus configured to connect the processing unit, the main memory, and the disaggregation controller, wherein the disaggregation controller includes: a disaggregation control agent configured to determine a requester that is to perform the read or write operation for the disaggregated memory based on a disaggregated memory delay corresponding to the disaggregated memory; a disaggregation direct requester configured to perform the read or write operation if the disaggregated memory delay is less than or equal to a threshold value; and a disaggregation indirect requester configured to perform the read or write operation if the disaggregated memory delay is greater than the threshold value.

The disaggregated memory delay may be a sum of a delay according to a distance to the disaggregated memory and a delay occurring in the disaggregation controller connected to the processing unit via a memory bus, and a delay according to performance and a response speed of the disaggregated memory.

The disaggregation control agent may be configured to: determine a port to be connected to the disaggregated memory based on a memory address corresponding to the read or write operation; manage a disaggregated memory delay value for each connectable disaggregated memory; and operate according to a request and response protocol of the memory bus and a bus switch connected to the disaggregation controller so that the processing unit recognizes the disaggregation controller as a combination of one memory controller and one memory, and distinguish between a direct access state and an indirect access state.

The disaggregation direct requester and the disaggregation indirect requester may be configured to generate a request disaggregated memory frame according to the read or write operation, transmit the request disaggregated memory frame to the disaggregated memory, and terminate a received response disaggregated memory frame.

If the processing unit performs a read or write operation, the disaggregation direct requester may be configured to generate a request disaggregated memory frame including write data in case of a write operation, transmit the request disaggregated memory frame to the disaggregated memory, receive a response disaggregated memory frame including read data in case of a read operation from the disaggregated memory, and transmit a memory bus response signal for informing a read data and read state in case of a read operation or a write state in case of a write operation to the processing unit through a memory bus.

If the processing unit performs a write operation, the disaggregation indirect requester may be configured to: return an indirect access response signal including state information for checking a state in which a write request is performed to the processing unit through a requested memory bus, before the disaggregated memory responds; designate a memory address and a memory space accessible by the processing unit and the disaggregation indirect requester and used to check a response state of the disaggregated memory; generate a request disaggregated memory frame including write data and transmit the request disaggregated memory frame to the disaggregated memory; receive a response disaggregated memory frame from the disaggregated memory; display a response state of the disaggregated memory to the write request in a memory address of a memory accessible by the processing unit; and notify the processing unit that the response state of the disaggregated memory to the write request has been updated.

If the processing unit performs a read operation, the disaggregation indirect requester may be configured to: return an indirect access response signal including state information for checking a state in which a read request is performed to the processing unit through a requested memory bus, before the disaggregated memory responds; designate a memory address and a memory space accessible by the processing unit and the disaggregation indirect requester and used to check a response state of the disaggregated memory and read data; generate a request disaggregated memory frame for performing a read operation and transmit the request disaggregated memory frame to the disaggregated memory; receive a response disaggregated memory frame including read data from the disaggregated memory; store the read data and a response state of the disaggregated memory to the read request in the received response disaggregated memory frame in a memory space of a memory address identifiable by the processing unit; and notify the processing unit that a read state of the disaggregated memory and the read data have been updated.

According to another aspect, there is provided a method of operating a disaggregated memory including: determining a requester that is to perform a data read or write operation of a processing unit for a disaggregated memory based on a disaggregated memory delay corresponding to the disaggregated memory; and performing the read or write operation through a requester determined from among a disaggregation direct requester and a disaggregation indirect requester.

The disaggregated memory delay may be a sum of a delay according to a distance to the disaggregated memory and a delay occurring in a disaggregation controller connected via a memory bus to the processing unit that operates the disaggregated memory, and a delay according to performance and a response speed of the disaggregated memory.

The performing may include generating a request disaggregated memory frame according to the read or write operation, transmitting the request disaggregated memory frame to the disaggregated memory, and terminating a received response disaggregated memory frame.

If the read or write operation is performed by the disaggregation direct requester, the performing may include generating a request disaggregated memory frame including write data in case of a write operation, transmitting the request disaggregated memory frame to the disaggregated memory, receiving a response disaggregated memory frame including read data in case of a read operation from the disaggregated memory, and transmitting a memory bus response signal for informing a read data and read state in case of a read operation or a write state in case of a write operation to the processing unit through a memory bus.

If the write operation is performed by the disaggregation indirect requester, the performing may include: returning an indirect access response signal including state information for checking a state in which a write request is performed to the processing unit through a requested memory bus, before the disaggregated memory responds; designating a memory address and a memory space accessible by the processing unit and the disaggregation indirect requester and used to check a response state of the disaggregated memory, generating a request disaggregated memory frame including write data and transmitting the request disaggregated memory frame to the disaggregated memory; receiving a response disaggregated memory frame from the disaggregated memory; and displaying a response state of the disaggregated memory to the write request in a memory address of a memory accessible by the processing unit, and notifying the processing unit that the response state of the disaggregated memory to the write request has been updated.

If the read operation is performed by the disaggregation indirect requester, the performing may include: returning an indirect access response signal including state information for checking a state in which a read request is performed to the processing unit through a requested memory bus, before the disaggregated memory responds; designate a memory address and a memory space accessible by the processing unit and the disaggregation indirect requester and used to check a response state of the disaggregated memory and read data; generating a request disaggregated memory frame for performing a read operation and transmitting the request disaggregated memory frame to the disaggregated memory; receiving a response disaggregated memory frame including read data from the disaggregated memory; storing the read data and a response state of the disaggregated memory to the read request in the received response disaggregated memory frame in a memory space of a memory address identifiable by the processing unit; and notifying the processing unit that a read state of the disaggregated memory and the read data have been updated.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a computing system according to a related art;

FIG. 2 is a diagram illustrating a computing system to which a method for disaggregation according to an example embodiment is applied; and

FIG. 3 is a diagram illustrating an operation of the computing system shown in FIG. 2.

### DETAILED DESCRIPTION

Specific structural or functional descriptions of example embodiments are disclosed for the purpose of illustration only, and may be changed and implemented in various forms. Accordingly, forms in which actual implementation is made are not limited to the specific example embodiments disclosed, and the scope of the present specification includes changes, equivalents, or substitutes included in the technical idea described in the example embodiments.

Although terms such as first or second may be used to describe various components, these terms should be construed only for the purpose of distinguishing one component from another. For example, a first component may be termed a second component, and similarly, a second component may also be termed a first component. It should be understood that when a component is referred to as being “connected” to another component, it may be directly connected or coupled to that another component, but another component may exist in-between.

Singular expressions include plural expressions unless clearly indicated otherwise in the context. It is to be understood that terms such as “comprise” or “have” in this specification are intended to specify the presence of the described features, numbers, steps, operations, components, parts, or combinations thereof, but not to preclude the possibility of the presence or addition of one or more other features, numbers, steps, operations, components, parts, or combinations thereof.

Unless defined otherwise, all terms used herein including technical or scientific terms have the same meaning as commonly understood by one of ordinary skill in the art. Terms such as those defined in commonly used dictionaries should be interpreted as having a meaning that is consistent with their meaning in the context of the relevant art, and will not be interpreted in an idealized or overly formal sense unless explicitly so defined herein.

Hereinafter, example embodiments will be described in detail with reference to the accompanying drawings. In describing while referring to the accompanying drawings, the same components are assigned the same reference numerals regardless of reference symbols, and the overlapping description thereof will be omitted.

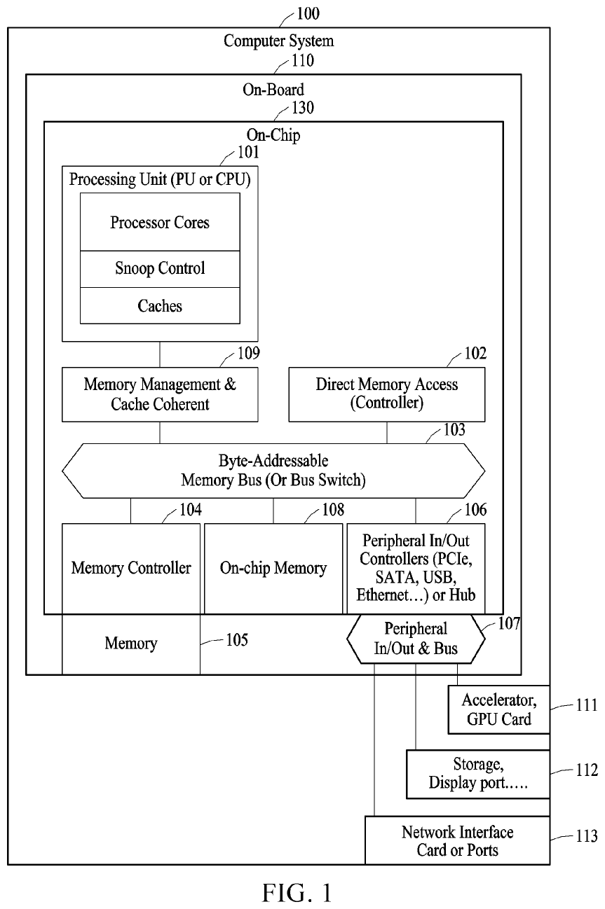

FIG. 1 is a diagram illustrating a computing system according to a related art.

In a computing system 100 according to the related art, a processing unit 101, a direct memory access (DMA) controller 102, a memory bus 103 or bus switch 103, a memory controller 104, an on-chip memory 108, memory management & cache coherent 109, a main memory 150, peripheral in/out controllers 106, and a peripheral in/out and bus 107 may be implemented on a single board or on a card board or sub-board connected to a main board by connectors.

For example, the board 110 (e.g., a main board) may include at least one or more chips 130, the processing unit 101, the DMA controller 102, the memory bus 103 or bus switch 103, the memory controller 104, the on-chip memory 108, the memory management and cache coherent 109, and the peripheral in/out controllers 106 may be implemented on the chip 130, the main memory 150 may be implemented external to the chip 130, the peripheral in/out controllers 106 may be implemented to be connected to peripheral devices outside the chip 130 through the peripheral in/out and bus 107 for connection with peripheral devices. Peripheral devices 111 to 113 such as accelerators, graphics processing units (GPUs), storages, display ports, and network interface cards (NICs) may be implemented on a card board or a sub-board. Connections between chips and/or between boards may be made by electrical signal cables (e.g., buses) and/or connectors.

The processing unit 101 (e.g., a central processing unit (CPU)) may use a memory in data processing and calculation processes when an operating system (OS) and/or application software is run. The memory may be divided into the main memory 105 that is present outside the chip and connected to the memory controller 104, the on-chip memory 108 present inside the chip, and/or the cache memory present inside the processing unit 101, depending on their locations.

The OS may divide and manage the memory into a code area, a data area, a stack area, and a heap area, allow programs to be loaded into the memory and executed, and allow variables and data information used by the program to be saved and stored in the memory so that the program may be executed normally.

As a number of cores of the processing unit 101 increases, the cache may be layered and used as L1, L2, L3 caches, and the like in order for the cores to perform parallel processing smoothly. For example, L1 may be used by a specific core and have a small capacity but a high access speed, and L2 and L3 may be accessed by multiple cores together and have a large capacity but a relatively low access speed. The cache may be used by being divided into I-cache (instruction-cache), which fetches and uses executable instructions, and D-cache (data-cache), which temporarily stores and uses data, depending on the usage.

In addition to the cache memory, the on-chip memory 108 may be present inside the processing unit 101 to use instructions and data together with peripheral devices within the chip. The processing unit 101 may be connected to the peripheral devices 111 to 113 via the peripheral in/out controllers 106.

The processing unit 101 and the peripheral devices 111 to 113 may use instructions and data stored in the main memory 105 together. The memory controller 104, the peripheral in/out controllers 106, and the processing unit 101 may be connected by the memory bus 103 to enable reading and writing in a byte-addressable manner, and there may be a bus switch 103 for multiple connections as necessary.

The processing unit 101 may perform an operation of reading and writing data through a read and write operation to a bus dedicated to a specific memory via the memory controller 104, and the memory controller 104 may perform a read and write operation on data contained in the memory at a nanosecond level based on a clock managed by the processing unit in order to prevent a decrease of the read and write performance of the processing unit 101, thereby responding to the processing unit 101. The processing unit 101 may need to be able to recognize a read and write response that is quickly processed in a cycle of several clocks, and may wait until a read operation or a write operation is completed.

The processing unit 101 may access the memory controller 104 via the memory bus 103 inside the chip 130, and may be connected to the main memory 105 on the board 110 outside the chip 130 via the memory controller 104. The memory bus 103 may immediately recognize completion of the read and write operation via a response signal in the memory bus 103 when performing a read and write operation.

When the processing unit 101 performs an operation of writing and reading data to the peripheral devices 111 to 113 other than the main memory 105, since the data need to be converted into network frames or packets, or converted to be suitable for a data format of the peripheral devices 111 to 113, a relatively large amount of time may be required for the processing unit 101 to complete the reading and writing, and a late response signal may decrease the performance of the overall operation of the processing unit 101.

The processing unit 101 may perform data read and write operations with the peripheral devices 111 to 113 using the DMA controller 102. In the present specification, a write operation of the DMA controller 102 may be referred to as “data transmission” and a read operation may be referred to as “data reception”. The processing unit 101 may store data in the main memory 105, and drive the DMA controller 102 so that the DMA controller 102 may transfer the data of the main memory 105 to the peripheral devices 111 to 113 or perform its reverse process.

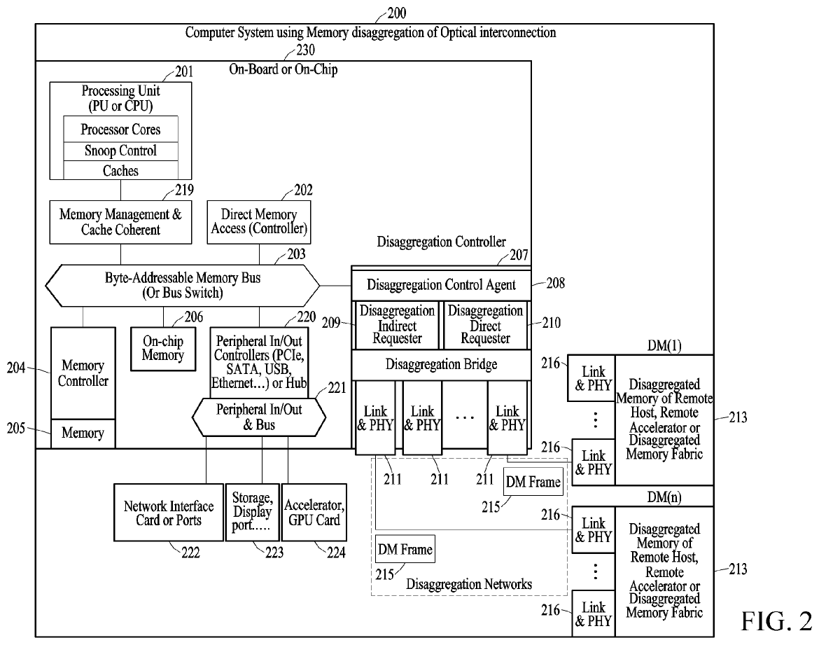

FIG. 2 is a diagram illustrating a computing system to which a method for disaggregation according to an example embodiment is applied.

In a computing system 200, processing units of different characteristics, such as a CPU, a GPU and/or accelerators, may exist on different boards that are physically separated from each other beyond the restrictions of board-to-board connector connections, and it is possible to expand computational power of homogeneous clusters such as CPU clusters and/or GPU clusters as well as to perform calculation and data processing utilizing processing units of different characteristics together. The computing system 200 may include interconnections between each processing unit and a connected memory (e.g., an on-chip memory, a main memory) of each processing unit, and interconnections with physically separate memories, when processing units are physically present on different boards to operate a large-scale program.

The computing system 200 may include a processing unit 201, a DMA controller 202, a memory bus 203 or bus switch 203, a memory controller 204, a main memory 150, an on-chip memory 206, memory management & cache coherent 220, and peripheral in/out controllers 221 within a board 230, and may include peripheral devices 222 to 224 such as accelerators, GPUs, storages, display ports, and NICs on a card board or auxiliary board, similarly to the computing system 100 shown in FIG. 1.

The computing system 200 may further include a disaggregation controller 207 within the board 230. The disaggregation controller 207 connected to the processing unit 201 may include a disaggregation control agent 208, a disaggregation indirect requester 209, a disaggregation direct requester 210, a disaggregation bridge 212, and an interface 211 that includes a link and a physical layer.

The disaggregation controller 207 may convert each address, data, and control information for reading and writing of the byte-addressable memory bus 203 into a request disaggregated memory (DM) frame 215, may transmit the request disaggregated memory frame 215 to a disaggregated memory (DM) 213, and may receive a response disaggregated memory frame 215 from the disaggregated memory 213.

The disaggregated memory 213 may receive the request disaggregated memory frame 215 from the disaggregation controller 207 through an interface 216 including a link and a physical layer. The disaggregated memory 213 may write or read data to or from a memory according to a read and write instruction of the disaggregated memory frame 215, may generate a response disaggregated memory frame 215 and may transmit the response disaggregated memory frame 215 to the disaggregation controller 207.

The disaggregation control agent 208 may be connected to the processing unit 201 via a memory bus 203 or a bus switch 203, and the processing unit 201 may recognize the disaggregation controller 207 as a combination of another memory controller and a memory, rather than recognizing it as a peripheral device or a network card.

The processing unit 201 may access the disaggregated memory 213 via the disaggregation direct requester 210 or the disaggregation indirect requester 209 when accessing the disaggregated memory 213 via the disaggregation controller 207.

If the processing unit 201 accesses the disaggregated memory 213 via the disaggregation direct requester 210, the processing unit 201 may operate in the same request and response protocol of a memory bus. However, if the processing unit 201 accesses the disaggregated memory 213 via the disaggregation indirect requester 209, the processing unit 201 may have a request and response protocol for the reading and writing of the processing unit 201 different from an existing memory bus protocol, and may use a DMA controller 202. In this case, although the DMA controller 202 may be used, the example embodiments are not limited thereto, the disaggregation controller 207 may include its own DMA controller therein, and the processing unit may distinguish between a direct access and an indirect access by expanding and newly defining information of a control signal of the request and response protocol for the reading and writing.

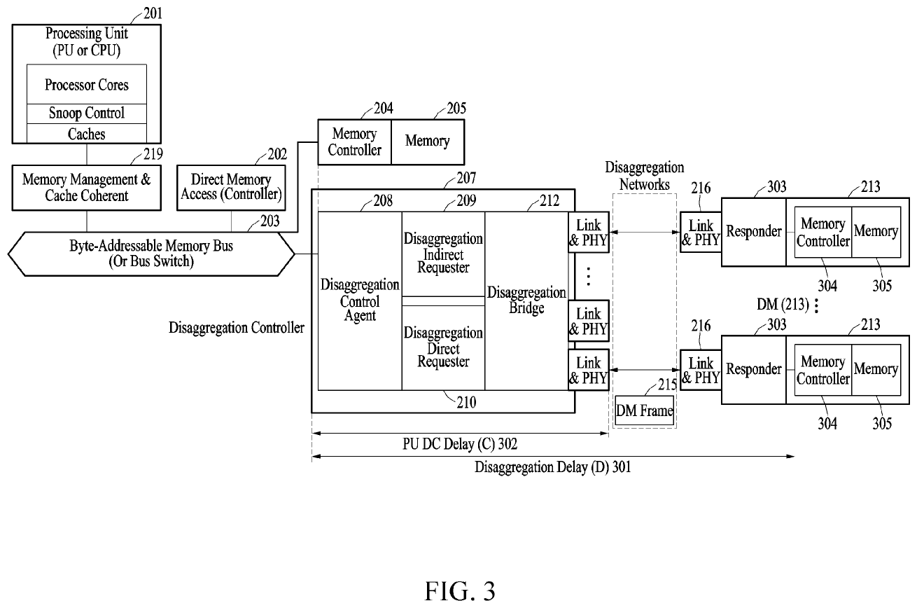

FIG. 3 is a diagram for describing an operation of the computing system shown in FIG. 2.

When the processing unit 201 accesses the disaggregated memory 213 via the disaggregation controller 207, a read and write instruction of the memory bus 203 may be converted into the request disaggregated memory frame 215 and the request disaggregated memory frame 215 may be transmitted to the disaggregated memory 213. The disaggregated memory 213 may store data in the disaggregated memory 213 according to a write request of the received request disaggregated memory frame 215 or may generate a response disaggregated memory frame 215 in response to a request, and may transmit response with read data and/or read and write state information to the processing unit 201 via the response disaggregated memory frame 215.

If a memory controller 304 and a memory 305 of the disaggregated memory 213 have the same specification as those of the memory controller 204 and the memory 205 on the same board as the processing unit 201, when the processing unit 201 accesses the disaggregated memory 213 and performs reading and writing, a disaggregation delay D may occur.

The disaggregation delay D may include a round-trip delay until a read or write request of the processing unit 201 arrives at the memory controller 304 of the disaggregated memory 213, and then a response of the disaggregated memory 213 in response to the request arrives at the bus 203 of the processing unit 201. For example, different types of disaggregation memories 213 may have different response delay characteristics in reading and writing, and accordingly a read delay RD and a write delay WD may be managed separately.

The disaggregation controller delay of a processing unit, PU DC Delay (C), 302 may be a delay caused by the disaggregation controller 207 of the processing unit 201. A change in a data length difference may be managed and added to delay characteristics and may be managed through an arithmetic calculation according to a data length. However, in an example embodiment of the present disclosure, the change in the data length difference may not be separately managed and reflected, and if the disaggregation controller 207 is implemented as hardware logic, a change in an average delay for the PU DC Delay (C) 302 may not be great.

The disaggregation delay D may depend on a transmission distance of a physical layer and a link to the disaggregated memory 213, and if disaggregation memories 213 are of different types, the disaggregation delay D may also depend on a disaggregated memory device delay DM, which is a delay according to the memory performance and a response speed.

To manage response delays for different disaggregation memories 213 in the processing unit 201, a disaggregated memory delay DMD may depend on a sum “D−C+DM” of a difference “D−C” between the disaggregation delay D and a disaggregation controller delay C of the processing unit 201 and the disaggregated memory device delay DM, and a disaggregated memory delay DMD may be used in an access control operation of the disaggregation controller 207. However, the disaggregated memory delay DMD may be generated by a new combination of delay elements induced for memory disaggregation, if necessary.

For the disaggregated memory delay DMD, a value of the disaggregated memory delay DMD for each disaggregated memory 213 connected to each interface 211 (e.g., a port) that functions to transmit the disaggregated memory frame 215 of the disaggregation controller 207 may be managed by the disaggregation control agent 208.

When the processing unit 201 accesses the disaggregated memory 213 via the memory bus 203 based on information such as a specific memory address and memory characteristics related to a preset disaggregated memory 213, the disaggregation control agent 208 may determine which disaggregated memory 213 is to be accessed through a specific address information field or address information of the memory.

The disaggregation control agent 208 may have a table that maps the port 211 associated with a specific memory address and the disaggregated memory delay DMD, and a threshold value of the disaggregated memory delay DMD may be set via the disaggregation control agent 208.

If a disaggregated memory delay DMD corresponding to a specific memory address is less than or equal to the threshold value, generation and response processing of the disaggregated memory frame 215 related to reading and writing of a memory address may be performed via the disaggregation direct requester 210. A read and/or write request of a memory address may be generated as a request disaggregated memory frame 215 and transmitted to the disaggregated memory 213. After reading and/or writing to the memory 305 of the disaggregated memory 213 is completed, the responder of the disaggregated memory 213 may transmit a response disaggregated memory frame 215, and the processing unit 201 may receive a memory bus response signal for checking a read and/or write state and complete an operation. The disaggregated memory frame 215 may include write data and read data, depending on reading and/or writing.

If the disaggregated memory delay DMD of a specific memory address is greater than the threshold value, the generation and response processing of the disaggregated memory frame 215 related to the reading and writing of the memory address may be performed via the disaggregation indirect requester 209. A read and/or write request of a memory address may be generated as a request disaggregated memory frame 215 and transmitted to the disaggregated memory 213, and in this case, before the disaggregated memory responds, the processing unit 201 may receive an indirect access response signal including state information for checking a state in which a write request is performed via a requested memory bus.

If a write operation is performed, the disaggregation controller 207 may return an indirect access response signal including state information for checking a state in which a write request is performed to the processing unit 201. The disaggregation indirect requester 209 may designate a memory address and a memory space that may be accessible by the processing unit 201 and the disaggregation indirect requester 209 and that may be used to check a response state of the disaggregated memory 213. The processing unit 201 may complete an indirect access request by receiving the indirect access response signal. The disaggregation indirect requester 209 may generate a request disaggregated memory frame 215 including write data to perform a write operation and transmit the request disaggregated memory frame 215. When the request disaggregated memory frame 215 is received and writing to the memory 305 of the disaggregated memory 213 is completed, a responder 303 of the disaggregated memory 213 may transmit a response disaggregated memory frame 215 to the processing unit 201. The disaggregation indirect requester 209 may receive the response disaggregated memory frame 215, may display a response state of the disaggregated memory 213 to the write request in a memory address of the main memory 205 that is accessible and identifiable by the processing unit 201, and may notify the processing unit 201 that the response state of the disaggregated memory 213 to the write request has been updated.

If a read operation is performed, the disaggregation controller 207 may return an indirect access response signal including state information for checking a state in which a read request is performed to the processing unit 201 via the requested memory bus 203, before the disaggregated memory 213 responds. The disaggregation indirect requester 209 may designate a memory address and a memory space that may be accessible by the processing unit 201 and the disaggregation indirect requester 209 and that may be used to check a response state of the disaggregated memory 213 and read data. The processing unit 201 may complete an indirect access request by receiving the indirect access response signal. The disaggregation indirect requester 209 may generate and transmit a request disaggregated memory frame 215 for performing a read operation. When reading to the memory 305 of the disaggregated memory 213 is completed, the responder 303 of the disaggregated memory 213 may transmit a response disaggregated memory frame 215 to the processing unit. The disaggregation indirect requester 209 may receive the response disaggregated memory frame 215, may store the read data and a response state of the disaggregated memory 213 to the read request in the received response disaggregated memory frame in a memory space of an address of the main memory 205 identifiable by the processing unit 201, and may notify the processing unit 201 that a read state for the disaggregated memory 213 and the read data have been updated.

The disaggregation control agent 208 may operate in a request and response protocol of the memory bus and bus switch connected to the disaggregation controller 207 so that the processing unit 201 may recognize the disaggregation controller 207 as a combination of one memory controller and one memory. The disaggregation control agent 208 may distinguish between a direct access state and an indirect access state by expanding information of a control signal of a request and response protocol for reading and writing, while exchanging information necessary for a direct access and an indirect access with the processing unit 201.

The disaggregated memory frame 215 transmitted to or received from the disaggregation direct requester 210 and the disaggregation indirect requester 209 may be transmitted or received via a corresponding port 211 through the disaggregation bridge 212.

The components described in the example embodiments may be implemented by hardware components including, for example, at least one digital signal processor (DSP), a processor, central processing unit (CPU), graphics processing unit (GPU), a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The example embodiments described herein may be implemented using a hardware component, a software component and/or a combination thereof. A processing unit may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing unit may run an OS and one or more software applications that run on the OS. The processing unit also may access, store, manipulate, process, and create data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or uniformly instruct or configure the processing unit to operate as desired. Software and data may be embodied permanently or temporarily in any type of machine, component, physical or virtual equipment, computer storage medium or device, or in a propagated signal wave capable of providing instructions or data to or being interpreted by the processing unit. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules to perform the operations of the above-described examples, or vice versa.

As described above, although the example embodiments have been described with reference to the limited drawings, a person skilled in the art may apply various technical modifications and variations based thereon. For example, appropriate results can be achieved even if the techniques described are performed in a different order than the method described, and/or the components such as the described systems, architecture, structures, devices, circuits, etc. are connected or combined in a different form than the method described, or are replaced or substituted by other components or equivalents.

Therefore, other implementations, other example embodiments, and equivalents to the claims are also within the scope of the following claims.

What is claimed is:

1. A disaggregation controller comprising:
a disaggregation control agent configured to determine a requester that is to perform a data read or write operation of a processing unit for a disaggregated memory based on a disaggregated memory delay corresponding to the disaggregated memory;
a disaggregation direct requester configured to perform the read or write operation if the disaggregated memory delay is less than or equal to a threshold value; and
a disaggregation indirect requester configured to perform the read or write operation if the disaggregated memory delay is greater than the threshold value.

2. The disaggregation controller of claim 1, wherein the disaggregated memory delay is a sum of a delay according to a distance to the disaggregated memory and a delay occurring in the disaggregation controller connected to the processing unit via a memory bus, and a delay according to performance and a response speed of the disaggregated memory.

3. The disaggregation controller of claim 1, wherein the disaggregation control agent is configured to:
determine a port to be connected to the disaggregated memory based on a memory address corresponding to the read or write operation;
manage a disaggregated memory delay value for each connectable disaggregated memory; and
operate according to a request and response protocol of a memory bus and a bus switch connected to the disaggregation controller so that the processing unit recognizes the disaggregation controller as a combination of one memory controller and one memory, and distinguish between a direct access state and an indirect access state.

4. The disaggregation controller of claim 1, wherein the disaggregation direct requester and the disaggregation indirect requester are configured to:
generate a request disaggregated memory frame according to the read or write operation and transmit the request disaggregated memory frame to the disaggregated memory; and
terminate a received response disaggregated memory frame.

5. The disaggregation controller of claim 1, wherein, if the processing unit performs a read or write operation, the disaggregation direct requester is configured to generate a request disaggregated memory frame including write data in case of a write operation, transmit the request disaggregated memory frame to the disaggregated memory, receive a response disaggregated memory frame including read data in case of a read operation from the disaggregated memory, and transmit a memory bus response signal for informing a read data and read state in case of a read operation or a write state in case of a write operation to the processing unit through a memory bus.

6. The disaggregation controller of claim 1, wherein, if the processing unit performs a write operation, the disaggregation indirect requester is configured to:
return an indirect access response signal including state information for checking a state in which a write request is performed to the processing unit through a requested memory bus, before the disaggregated memory responds;
designate a memory address and a memory space accessible by the processing unit and the disaggregation indirect requester and used to check a response state of the disaggregated memory;
generate a request disaggregated memory frame including write data and transmit the request disaggregated memory frame to the disaggregated memory;
receive a response disaggregated memory frame from the disaggregated memory;
display a response state of the disaggregated memory to the write request in a memory address of a memory accessible by the processing unit; and
notify the processing unit that the response state of the disaggregated memory to the write request has been updated.

7. The disaggregation controller of claim 1, wherein, if the processing unit performs a read operation, the disaggregation indirect requester is configured to:
return an indirect access response signal including state information for checking a state in which a read request is performed to the processing unit through a requested memory bus, before the disaggregated memory responds;
designate a memory address and a memory space accessible by the processing unit and the disaggregation indirect requester and used to check a response state of the disaggregated memory and read data;
generate a request disaggregated memory frame for performing a read operation and transmit the request disaggregated memory frame to the disaggregated memory;
receive a response disaggregated memory frame including read data from the disaggregated memory;
store the read data and a response state of the disaggregated memory to the read request in the received response disaggregated memory frame in a memory space of a memory address identifiable by the processing unit; and
notify the processing unit that a read state of the disaggregated memory and the read data have been updated.

8. A computing system comprising:
a processing unit;
a main memory;
a disaggregation controller configured to control a read or write operation for a disaggregated memory of the processing unit; and
a memory bus configured to connect the processing unit, the main memory, and the disaggregation controller,
wherein the disaggregation controller comprises:
a disaggregation control agent configured to determine a requester that is to perform the read or write operation for the disaggregated memory based on a disaggregated memory delay corresponding to the disaggregated memory;
a disaggregation direct requester configured to perform the read or write operation if the disaggregated memory delay is less than or equal to a threshold value; and
a disaggregation indirect requester configured to perform the read or write operation if the disaggregated memory delay is greater than the threshold value.

9. The computing system of claim 8, wherein the disaggregated memory delay is a sum of a delay according to a distance to the disaggregated memory and a delay occurring in the disaggregation controller connected to the processing unit via a memory bus, and a delay according to performance and a response speed of the disaggregated memory.

10. The computing system of claim 8, wherein the disaggregation control agent is configured to:
determine a port to be connected to the disaggregated memory based on a memory address corresponding to the read or write operation;
manage a disaggregated memory delay value for each connectable disaggregated memory; and
operate according to a request and response protocol of the memory bus and a bus switch connected to the disaggregation controller so that the processing unit recognizes the disaggregation controller as a combination of one memory controller and one memory, and distinguish between a direct access state and an indirect access state.

11. The computing system of claim 8, wherein the disaggregation direct requester and the disaggregation indirect requester are configured to generate a request disaggregated memory frame according to the read or write operation and transmit the request disaggregated memory frame to the disaggregated memory.

12. The computing system of claim 8, wherein, if the processing unit performs a read or write operation, the disaggregation direct requester is configured to generate a request disaggregated memory frame including write data in case of a write operation, transmit the request disaggregated memory frame to the disaggregated memory, receive a response disaggregated memory including read data in case of a read operation frame from the disaggregated memory, and transmit a memory bus response signal for informing a read data and read state in case of a read operation or a write state in case of a write operation to the processing unit through a memory bus.

13. The computing system of claim 8, wherein, if the processing unit performs a write operation, the disaggregation indirect requester is configured to:
return an indirect access response signal including state information for checking a state in which a write request is performed to the processing unit through a requested memory bus, before the disaggregated memory responds;
designate a memory address and a memory space accessible by the processing unit and the disaggregation indirect requester and used to check a response state of the disaggregated memory;
generate a request disaggregated memory frame including write data and transmit the request disaggregated memory frame to the disaggregated memory;
receive a response disaggregated memory frame from the disaggregated memory;
display a response state of the disaggregated memory to the write request in a memory address of a memory accessible by the processing unit; and
notify the processing unit that the response state of the disaggregated memory to the write request has been updated.

14. The computing system of claim 8, wherein, if the processing unit performs a read operation, the disaggregation indirect requester is configured to:
return an indirect access response signal including state information for checking a state in which a read request is performed to the processing unit through a requested memory bus, before the disaggregated memory responds;
designate a memory address and a memory space accessible by the processing unit and the disaggregation indirect requester and used to check a response state of the disaggregated memory and read data, wherein the processing unit receives the indirect access response signal to complete an indirect access request;
generate a request disaggregated memory frame for performing a read operation and transmit the request disaggregated memory frame to the disaggregated memory;
receive a response disaggregated memory frame including read data from the disaggregated memory;
store the read data and a response state of the disaggregated memory to the read request in the received response disaggregated memory frame in a memory space of a memory address identifiable by the processing unit; and
notify the processing unit that a read state of the disaggregated memory and the read data have been updated.

15. A method of operating a disaggregated memory, the method comprising:
determining a requester that is to perform a data read or write operation of a processing unit for a disaggregated memory based on a disaggregated memory delay corresponding to the disaggregated memory; and
performing the read or write operation through a requester determined from among a disaggregation direct requester and a disaggregation indirect requester.

16. The method of claim 15, wherein the disaggregated memory delay is a sum of a delay according to a distance to the disaggregated memory and a delay occurring in a disaggregation controller connected via a memory bus to the processing unit that operates the disaggregated memory, and a delay according to performance and a response speed of the disaggregated memory.

17. The method of claim 15, wherein the performing comprises:
generating a request disaggregated memory frame according to the read or write operation, transmitting the request disaggregated memory frame to the disaggregated memory, and terminating a received response disaggregated memory frame.

18. The method of claim 15, wherein, if the read or write operation is performed by the disaggregation direct requester, the performing comprises:
generating a request disaggregated memory frame including write data in case of a write operation, transmitting the request disaggregated memory frame to the disaggregated memory, receiving a response disaggregated memory frame including read data in case of a read operation from the disaggregated memory, and transmitting a memory bus response signal for informing a read data and read state in case of a read operation or a write state in case of a write operation to the processing unit through a memory bus.

19. The method of claim 15, wherein, if the write operation is performed by the disaggregation indirect requester, the performing comprises:
returning an indirect access response signal including state information for checking a state in which a write request is performed to the processing unit through a requested memory bus, before the disaggregated memory responds;
designating a memory address and a memory space accessible by the processing unit and the disaggregation indirect requester and used to check a response state of the disaggregated memory, generating a request disaggregated memory frame including write data and transmitting the request disaggregated memory frame to the disaggregated memory;
receiving a response disaggregated memory frame from the disaggregated memory; and
displaying a response state of the disaggregated memory to the write request in a memory address of a memory accessible by the processing unit, and notifying the processing unit that the response state of the disaggregated memory to the write request has been updated.

20. The method of claim 15, wherein, if the read operation is performed by the disaggregation indirect requester, the performing comprises:
returning an indirect access response signal including state information for checking a state in which a read request is performed to the processing unit through a requested memory bus, before the disaggregated memory responds;
designate a memory address and a memory space accessible by the processing unit and the disaggregation indirect requester and used to check a response state of the disaggregated memory and read data;
generating a request disaggregated memory frame for performing a read operation and transmitting the request disaggregated memory frame to the disaggregated memory;
receiving a response disaggregated memory frame including read data from the disaggregated memory;
storing the read data and a response state of the disaggregated memory to the read request in the received response disaggregated memory frame in a memory space of a memory address identifiable by the processing unit; and
notifying the processing unit that a read state of the disaggregated memory and the read data have been updated.
